(19) United States
(12) Patent Application Publication
(10) Pub. No.: US 2019/0282348 A1
(43) Pub. Date: Sep. 19, 2019

(54) DEVICE FOR CLEANING TEETH

(71) Applicant: AMABRUSH GMBH, Vienna (AT)

(72) Inventor: Marvin MUSIALEK, Wien (AT)

(21) Appl. No.: 16/319,209

(22) PCT Filed: Jul. 19, 2017
(86) PCT No.: PCT/AT2017/060179

§ 371 Date: Jan. 18, 2019

(30) Foreign Application Priority Data
Jul. 19, 2016 (AT) A 50648/2016

(51) Int. Cl. A61C 17/22; A46B 11/00; A46B 9/04; A61C 17/34

(52) U.S. Cl. CPC A61C 17/228; A46B 11/001; A61C 17/0211; A61C 17/3481; A46B 9/045

(57) ABSTRACT

The invention relates to a device for cleaning teeth of a human or animal user with a mouthpiece to be placed in the user's mouth, having a support with cleaning elements arranged thereon, which cleaning elements are arranged on the support for simultaneous engagement with substantially all of the teeth of an upper jaw and/or a lower jaw of the user, and with an electric drive unit fastened detachably to the mouthpiece with at least one vibration element to execute a vibrating motion, wherein the cleaning elements are arranged on the support for simultaneous engagement with substantially all of the teeth of the upper jaw and the lower jaw of the user, and that a detachable magnetic connection is provided for the detachable fastening of the drive unit to the mouthpiece.

The invention relates to a device for cleaning the teeth of a human or animal user, with a mouthpiece to be placed in the user's mouth, having a support with cleaning elements arranged thereon, which cleaning elements are arranged on the support for simultaneous engagement with substantially all of the teeth in an upper jaw and/or a lower jaw of the user, and with an electric drive unit fastened detachably to the mouthpiece with at least one vibration element to execute a vibrating motion.

Teeth cleaning devices for the automatic cleaning of teeth are known from the prior art. Electric toothbrushes are equipped with a drive motor which sets a brush holder with cleaning brushes arranged thereon in motion, particularly in rotation. The cleaning brushes are brought into contact with one or more teeth by the user. There are also teeth cleaning devices known which have a for example horseshoe-shaped mouthpiece with bristles, which is inserted in the user's mouth and set in motion via a drive unit. In this way, substantially all teeth in an upper jaw or a lower jaw of the user can be cleaned simultaneously.

DE 10 2005 059 775 A1 discloses a device with a support body that can be introduced into a mouth and has a plurality of bristles which are attached movably for application to several teeth at once. The bristles may be arranged in tufts on bristle carriers which are connected to an electric drive device. Then, the movement created by the electric drive device is transmitted mechanically to the bristle carriers. In addition, the entire support body with the bristles can be caused to oscillate.

DE 20 2014 002 428 U1 discloses a teeth cleaning device with a rechargeable battery, an electric motor, a motion translator and two U-shaped cleaning elements with bristles of different lengths. The cleaning elements or mouthpieces are designed to rotate and are connected to the electric motor or disconnected therefrom by means of a twist/click system.

U.S. Pat. No. 4,011,616 relates to a teeth cleaning device with a horseshoe-shaped brush which is assembled detachably via a plug connection to a base of the same shape. The base is connected to a vibrating device via a rod in order to transmit the vibration thereof to the brush. Alternatively, a vibrating device may be connected directly to a brush which is seated movably on a base. A rod or cable passes through a tubular section of the base and connects the vibrating device detachably to the brush.

WO 2007/121760 A1 discloses a device for cleaning, massaging and/or polishing teeth and gums. In this case, U-shaped cleaning bodies each having two rows of brushes are connected to each other so as to be detachable or replaceable by means of a support arranged therebetween. The support has one or more movement apparatuses, particularly ultrasonic transducers, ultrasonic motors or magnetic motors, the movements of which are transmitted to the brushes. A bleach, a cleaning agent or a painkiller or the like may be introduced via a channel in the cleaning bodies.

U.S. Pat. No. 6,223,376 B1 relates to a toothbrush for infants, having a base body, an intermediate element which can be inserted in the base body, and a brush holder which can be inserted in the intermediate element, each of which are U-shaped and designed to be detachably connectable to each other. The base body has a handle for holding the toothbrush and—on the underside—a vibration section, which is controlled via a remote controller and moves the toothbrush continuously back and forth, to the left and to the right. Magnets may be provided for connecting the base body to the intermediate element.

The disadvantage of the known devices is that they are awkward to use, the drive unit is only detachable from the mouthpiece with difficulty or not at all, or that the cleaning of teeth with the devices described is time-consuming. Mouthpieces with electric component have the further drawback that replacing the mouthpieces due to wear or for reasons of hygiene is relatively expensive.

The object of the invention is to create a device of the kind described in the introduction, which is as simple as possible to operate, in particular also by people with limited hand mobility, and allows the mouthpiece or any other components therefore to be replaced inexpensively. Disadvantages of known devices should be prevented or at least alleviated.

The inventive object is solved in that the cleaning elements are arranged so as to engage with substantially all teeth of the user's upper jaw and lower jaw on the support at the same time, and that a detachable magnetic connection is provided for detachably fastening the drive unit to the mouthpiece. To clean the user's teeth, the mouthpiece of the cleaning device is inserted in the user's mouth. The mouthpiece has a support with cleaning elements which are arranged on the support in such manner that they come into engagement with substantially all of the teeth an upper jaw and a lower jaw of the user at the same time. Accordingly, the invention comprises devices for cleaning the teeth of the upper jaw and the lower jaw simultaneously. In order to set the mouthpiece and consequently the cleaning elements attached thereto into the necessary motion for the cleaning operation, an electric drive unit is provided which includes at least one vibration element for performing a vibrating motion. The drive unit preferably includes as many of the electrical components as possible, or particularly all electrical components of the cleaning device. The drive unit is arranged outside of the user's mouth and may be fastened to the mouthpiece particularly easily with the detachable magnetic connection, and disconnected from the mouthpiece again just as simply. The vibration element is arranged in the drive unit in such manner that its vibrating motion may be transmitted substantially to the entire drive unit and transmitted from this to the mouthpiece via the magnet connection. The magnetic connection can also be established and canceled again quickly and without difficulty by persons with limited hand mobility. This is particularly important, because the mouthpiece must be cleaned regularly for reasons of hygiene. In contrast to this, known plugged connections from the related art are inconvenient or entirely impossible to manipulate, and are therefore unsuitable. The magnetic connection also enables people with limited visual capacity to establish and cancel the connection between the drive unit and the mouthpiece reliably and quickly. The magnetic connection is designed to be both strong enough to prevent the drive unit from inadvertently becoming detached from the mouthpiece during operation, and at the same time only strong enough so that easy intentional detachment of the magnetic connection is possible without using great force.

According to a further feature of the invention, the at least one vibration element is formed by a piezoelement, an electromagnetic acoustic transducer or an unbalance motor, and is preferably constructed perpendicularly to the upper jaw and lower jaw in order to generate a vibrating motion. Piezoelements, electromagnetic acoustic transducers and unbalance motors are available at low cost, which is beneficial for the overall costs of the drive unit, and are noted for their good reliability. The piezoelement, the electromagnetic acoustic transducer or the unbalance motor are arranged in the drive unit and are attached thereto or therein in such manner that they transmit their vibrating motions to the drive unit, and the vibrating motions of the drive unit take place in plane that extends perpendicularly to a direction leading from the back teeth to the front teeth of the user.

To make it easier for the user to apply a dental care product to the cleaning elements, it is advantageous if the drive unit includes a receptacle for a dental care product and a pump for transporting the dental care product out of the receptacle to an outlet arranged in the area of the connection to the mouthpiece. In this way, the receptacle may contain a supply of the dental care product for multiple cleaning operations. Moreover, a quantity of the dental care product that is suitable for a single cleaning operation is transported to the outlet by the pump for each cleaning operation. The outlet is arranged in the area of the connection between the drive unit and the mouthpiece.

To ensure a compact, reliable design of the drive unit, it is advantageous if the pump is in the form of a piezoelectric micropump. However, the pump function may also be performed by a positive displacement pump or a flow-type pump.

It is particularly favorable if the receptacle has a filling opening for filling the receptacle with the dental care product. Thus, the receptacle may be refilled with dental care product after the quantity of dental care product in the receptacle has been used up. The filling opening may be formed for example by a valve, a lid or a push-through membrane, which can be opened and closed multiple times.

If the receptacle is designed to be replaceable, a filling opening in the receptacle may optionally be dispensed with. The dental care product may thus also be provided in disposable receptacles or cartridges or cassettes which can easily be replaced. During installation in the drive unit, the replaceable receptacle is preferably inserted by piercing a connecting line leading to the pump or similar.

Regarding the configuration of the mouthpiece, it is advantageous if the mouthpiece has an inlet arranged in the area of the connection to the drive unit, which aligns with the drive unit outlet when the drive unit is connected, which has at least one channel with multiple orifices on the support. The inlet of the mouthpiece is thus arranged congruently or at least partially overlapping with the outlet of the drive unit when the mouthpiece is connected to the drive unit in the used state of the cleaning device. The inlet of the mouthpiece and the outlet of the drive unit are arranged in the connection area between the mouthpiece and the drive unit. The connection area is that area in which the mouthpiece and the drive unit contact each other, or an area surrounded by this contact area. In order to distribute the dental care product transported from the receptacle through the outlet of the drive unit and the inlet of the mouthpiece appropriately at the mouthpiece, the inlet is connected to at least one channel which has several orifices on the support. The dental care product is preferably transported by means of the pump in the drive unit through the channel to the orifices, from where it reaches the cleaning elements and the teeth.

In a particularly advantageous embodiment, the detachable magnetic connection may be formed by at least one magnet and at least one magnetic or magnetizable counterpart. Accordingly, a magnet may be attached both on the drive unit and to the mouthpiece, which magnets are positioned so that their opposite poles face each other, to create the magnetic connection. In the same way, at least one magnet may be attached to the drive unit or the mouthpiece which can be magnetically connected to at least one magnetizable counterpart in the respective opposing mouthpiece or drive unit.

If the at least one magnet and the at least one counterpart are arranged in the form of a ring around the outlet on the drive unit and the inlet on the mouthpiece, when the drive unit is connected to the mouthpiece the outlet and the inlet may align with each other. In this way, not only is it possible to create a simple connection between the drive unit and the mouthpiece, but at the same time a connection for transporting the dental care product to the mouthpiece is also assured.

In order to render the transport of the dental care product to the mouthpiece more reliable still, it may be provided that the drive unit and the mouthpiece have guide elements to guarantee that the outlet for the dental care product on the drive unit and the inlet for the dental care product on the mouthpiece align correctly with each other. The guide elements may have simple geometric shapes so that they may be brought into mutual engagement with simple manipulations. For example, one ring each may be provided on the drive unit and the mouthpiece, the rings having different diameters, so that the one ring may be inserted or snapped inside the other ring. The guide elements may also be formed from the magnetic or magnetizable elements of the magnetic connection itself by lending them a corresponding design. Of course, many shapes other than rings are also conceivable for suitable guide elements. The essential feature of this arrangement is that the outlet and the inlet are aligned when the guide elements have been brought into their intended cooperating position by the user.

To supply energy to the drive unit, it is advantageous if the drive unit has an electrical energy store connected to the vibration element and the pump, particularly a rechargeable battery. In order to charge the energy store, an external charger may be provided, or the drive unit may include solar cells and electrical components to charge the energy store for this purpose. The charging device is preferably designed for energy self-sufficient charging of the energy store, particularly a rechargeable battery.

In order to configure the charging operation as simply as possible for the user, alternatively a device for preferably inductive charging of the energy store may also be provided. With the device for wireless energy transmission, for inductive coupling, for example, it is not necessary to make an electrical connection, particularly a plug connection between the drive unit and a power source for each charging operation.

Teeth cleaning may be carried out particularly efficiently if the cleaning elements are in the form of bristles. Accordingly, the bristles are preferably in contact with all teeth of the upper jaw and the lower jaw of the user when the device for cleaning teeth is inserted in the user's mouth in a position ready for use.

In order to avoid injuring the gums or teeth by exerting excessive pressure on the mouthpiece by the teeth, and at the same time to achieve optimal cleaning of the teeth, it is advantageous if at least one pressure sensor is arranged in the mouthpiece. The pressure sensor may detect the pressure exerted on the mouthpiece by the teeth and if a certain limit value for the pressure is exceeded a shutoff of the drive unit may be initiated. In order to evaluation the values detected, the pressure sensor may be connected to a data memory in the mouthpiece or in the drive unit. If the data memory is located in the drive unit, electrical contacts may be provided in the area of the magnetic connection, which connect the pressure sensor electrically to the data memory.

If the drive unit has a control device, preferably with a wireless data transmission interface, operating parameters of the drive unit may be changed and/or read out without difficulty. For example, the drive unit may be embodied and correspondingly controlled to perform various vibrating motions. Examples of such are oscillations with constant or variable frequency and/or amplitude. A data processing unit such as a PC, laptop or even a mobile phone is advantageously provided for the transmission of data to and from the drive unit. The data may be transmitted by radio or light signals and preferably using known transmission protocols.

The invention will be explained in greater detail with reference to the accompanying drawing. In the drawing:

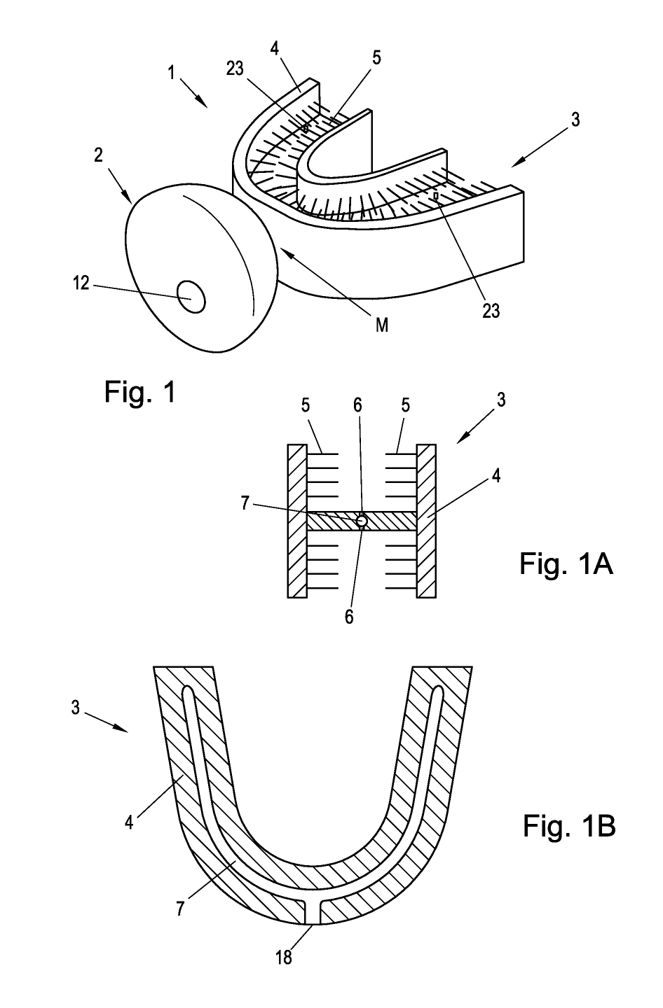

FIG. 1 is a perspective view of a device according to the invention for cleaning teeth, with a drive unit and a mouthpiece in an assembled state;

FIG. 1A is a cross-sectional view through the mouthpiece according to FIG. 1 in a substantially vertical plane;

FIG. 1B is a cross-sectional view through the mouthpiece according to FIG. 1 in a substantially horizontal plane;

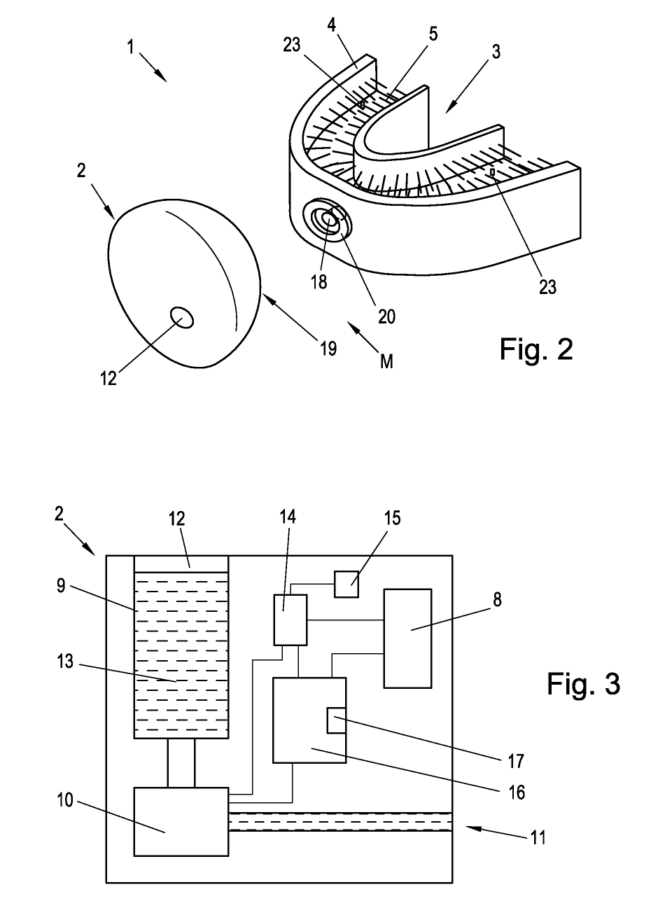

FIG. 2 is a perspective view of the device according to FIG. 1, wherein the drive unit and the mouthpiece are separated from each other;

FIG. 3 is a block diagram of the drive unit;

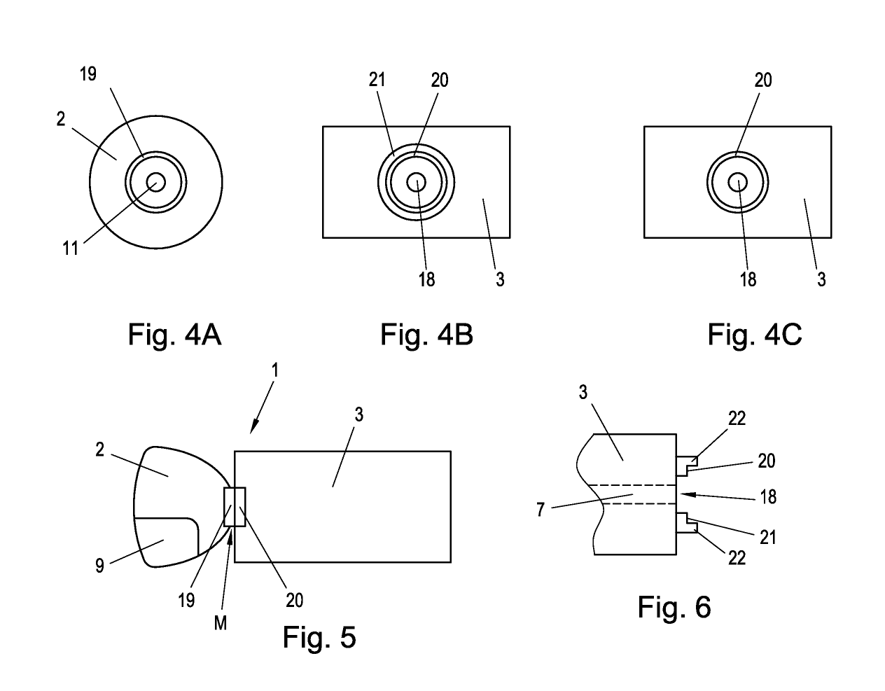

FIGS. 4A to 4C show front views of the surfaces of the drive unit and the mouthpiece facing each other in the assembled state;

FIG. 5 shows a side view of the drive unit and the mouthpiece in the assembled state; and

FIG. 6 shows a side view of a part of a mouthpiece in the area of the connection to the drive unit with a ring-shaped guide element.

FIG. 1 shows a device 1 for cleaning the teeth (not shown) of a human or animal user. Device 1 has an electric drive unit 2 and a mouthpiece 3 that is connectable thereto. In the ready-to-use state of device 1 shown in FIG. 1, electric drive unit 2 is connected or coupled to mouthpiece 3. Mouthpiece 3 is designed to be placed in the user's mouth, and for this purpose includes a support 4 and cleaning elements 5, particularly bristles, arranged thereon. Drive unit 2 is arranged outside the user's mouth. Support 4 for mouthpiece 3 includes a curved tray, open upwards to accommodate the teeth of the upper jaw and also a curved tray, open downwards to accommodate the teeth of the lower jaw. For efficient cleaning of the teeth, cleaning elements 5 preferably extend along the open trays of support 4 from the front to the back of mouthpiece 3. The mouthpiece 3 shown is designed for simultaneous engagement with substantially all of the teeth of an upper jaw and a lower jaw of the user. Electric drive unit 2 is designed to perform vibrating motions and may be fastened detachably to mouthpiece 3. For this purpose, a detachable magnetic connection M is provided. When drive unit 2 and mouthpiece 3 are connected, the vibrations generated are transmitted to mouthpiece 3 and subsequently to cleaning elements 5.

As it is shown in the cross-sectional images according to FIG. 1A and FIG. 1B of mouthpiece 3, a channel 7 runs in mouthpiece 3 and the support 4 therefor to transport a dental care product 13 (see FIG. 3), which channel ends in corresponding orifices 6, from where the dental care product 13 is able to reach cleaning elements 5 and the teeth. Channel 7 has an inlet 18 which cooperates with a corresponding outlet 11 on drive unit 2 (see FIG. 3). In FIGS. 1 and 1A, the cleaning elements 5 are only indicated schematically. Of course, cleaning elements 5 may also be arranged on the horizontal side of support 4, particularly for cleaning the chewing surfaces of the teeth.

Pressure sensors 23 may also be provided in mouthpiece 3 to detect the pressure on mouthpiece 3.

FIG. 2 shows device 1, wherein drive unit 2 and mouthpiece 3 are separated from each other. In this state, magnetic connection M is canceled. This enables mouthpiece 3 to be cleaned or replaced easily. Magnetic connection M is formed by at least one magnet 19 on drive unit 2 and at least one magnetic or magnetizable counterpart 20 on mouthpiece 3. Of course, magnet 19 may also be arranged on mouthpiece 3 and the magnetic or magnetizable counterpart 20 may be arranged on drive unit 2. Magnet 19 and the at least one counterpart 20 are preferably arranged in the form of a ring around outlet 11 on drive unit 2 and around inlet 18 on mouthpiece 3.

FIG. 3 shows a block diagram of drive unit 2. In the example illustrated, drive unit 2 has as vibration element 8, for example a piezoelement, an electromagnetic acoustic transducer or an unbalance motor, which generates the vibrating motions necessary for cleaning teeth. Drive unit 2 also contains a receptacle 9, in which a dental care product 13 may be held, and a pump 10 for transporting the dental care product 13 from receptacle 9 to an outlet 11 of drive unit 2. Outlet 11 of drive unit 2 is arranged in the area of the connection between drive unit 2 and mouthpiece 3. Pump 10 may be in the form of a piezoelectric micropump, a positive displacement pump or a flow-type pump. In order to replenish the dental care product 13, receptacle 9 has an inlet opening 12, for example a lid, a valve or a push-through membrane. Receptacle 9 may also be designed to be replaceable in the manner of a cartridge or cassette (see FIG. 5), so that it may be replaced very simply. For the energy supply to vibration element 8 and pump 10, drive unit 2 has an electrical energy store 14 connected therewith, particularly a rechargeable battery. This may be connected to a device 15 for preferably inductive charging of energy store 14. A control device 16 with a preferably wireless data transmission interface 17 may also be contained in drive unit 2 and may also be connected to energy store 14.

Mouthpiece 3 has an inlet 18 in the area of the connection with drive unit 2, which inlet aligns with outlet 11 of drive unit 2 when the drive unit 2 is connected (see FIG. 2). Inlet 18 is connected to channel 7, which ends at orifices 6 on support 4. In this way, the dental care product 13 is able to be transported out of receptacle 9 through outlet 11 and through inlet 18 via channel 7 and finally reach the cleaning elements 5 or bristles and teeth through orifices 6.

FIG. 4A shows a view of drive unit 2 with a part of the magnetic connection M, particularly a ring-shaped magnet 19, which is arranged around outlet 11 for the dental care product 13.

FIG. 4B represents a view of mouthpiece 3, wherein in this case a corresponding part of the magnetic connection M, particularly a ring-shaped magnetizable counterpart 20 is shown, and is arranged in the manner of a ring around inlet 18 for channel 7 on mouthpiece 3. A ring-shaped guide element 21 may be provided around the magnetizable counterpart 20 to ensure that outlet 11 and inlet 18 align correctly. Guide element 21 may be embodied as shown in FIG. 6 for example, by providing it with a collar 22 or the like, which serves accordingly to seat the counterpart on drive unit 2. When device 1 is in the connected state, the ring-shaped magnet 19 or the ring-shaped magnetizable counterpart 20 are drawn together by magnetic attraction and lie flush against each other.

FIG. 4C shows a magnetizable counterpart 20 functioning as a guide element 21 on mouthpiece 3.

FIG. 5 is a side view of drive unit 2 and mouthpiece 3 in the assembled state of device 1, with magnet 19 and magnetizable counterpart 20, which are advantageously of flat construction to create a large connection area. Receptacle 9 for the dental care product 13 on drive unit 2 is replaceable in the manner of cartridge or cassette. This enables receptacle 9 to be replaced quickly and easily.

1.-15. (canceled)

16. A device (1) for cleaning teeth of a human or animal user with a mouthpiece (3) to be placed in a user's mouth, having a support (4) with cleaning elements (5) arranged thereon, which cleaning elements (5) are arranged on the support (4) for simultaneous engagement of all of the teeth of an upper jaw and/or a lower jaw of the user, and with an electric drive unit (2) fastened detachably to the mouthpiece (3) with at least one vibration element (8) to execute a vibrating motion, wherein the cleaning elements (5) are arranged on the support (4) for simultaneous engagement of all of the teeth of the upper jaw and the lower jaw of the user, and that a detachable magnetic connection (M) is provided for the detachable fastening of the drive unit (2) to the mouthpiece (3), wherein the drive unit (2) is configured for arrangement outside the user's mouth and the vibration element (8) is arranged in the drive unit (2) in such manner that the vibrating motion thereof can be transmitted to the entire drive unit (2) and via the magnetic connection (M) to the mouthpiece (3) from said unit.

17. The device (1) according to claim 16, wherein the at least one vibration element (8) is formed by a piezoelement, an electromagnetic acoustic transducer or an unbalance motor and is designed to generate a vibrating motion preferably perpendicularly to the upper jaw and lower jaw.

18. The device (1) according to claim 16, wherein the drive unit (2) has a receptacle (9) for a dental care product (13) and a pump (10) for transporting the dental care product (13) out of the receptacle (9) to an outlet (11) arranged in the area of the connection with the mouthpiece (3).

19. The device (1) according to claim 18, wherein the pump (10) is formed by a piezoelectric micropump, a positive displacement pump or a flow-type pump.

20. The device (1) according to claim 18, wherein the receptacle (9) has a filling opening (12) for filling the receptacle (9) with the dental care product (13).

21. The device (1) according to claim 18, wherein the receptacle (9) is designed to be replaceable.

22. The device (1) according to claim 18, wherein the mouthpiece (3) has an inlet (18) arranged in the area of the connection with the drive unit (2), which inlet is aligned with the outlet (11) of the drive unit (2) when the drive unit (2) is connected, and the inlet (18) is connected to at least one channel (7), which has at least one channel (7) with multiple orifices (6) on the support (4).

23. The device (1) according to claim 16, wherein the detachable magnetic connection (M) is formed by at least one magnet (19) and at least one magnetic or magnetizable counterpart (20).

24. The device (1) according to claim 23, wherein the at least one magnet (19) and the at least one counterpart (20) are arranged in the form of a ring around the outlet (11) on the drive unit (2) and the inlet (18) on the mouthpiece (3).

25. The device (1) according to claim 22, wherein the drive unit (2) and the mouthpiece (3) have guide elements (21) to ensure that the outlet (11) on the drive unit (2) for the dental care product (13) and the inlet (18) on the mouthpiece (3) for the dental care product (13) are aligned correctly.

26. The device (1) according to claim 18, wherein the drive unit (2) has an electrical energy store (14), particularly a rechargeable battery, which is connected to the vibration element (8) and the pump (10).

27. The device (1) according to claim 26, wherein a device (15) is provided for inductive charging of the energy store (14).

28. The device (1) according to claim 16, wherein the cleaning elements (5) are formed by bristles.

29. The device (1) according to claim 16, wherein at least one pressure sensor (23) is arranged in the mouthpiece (3).

30. The device (1) according to claim 16, wherein the drive unit (2) has a control device (16), preferably with a wireless data transmission interface (17).
